(19) United States
(12) Patent Application Publication
(10) Pub. No.: US 2006/0107262 A1
(43) Pub. Date: May 18, 2006

(54) Power consumption-based thread scheduling

(75) Inventors: Devadatta V. Bodas, Federal Way, WA (US); Jun Nakajima, San Ramon, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: INTEL CORPORATION

(21) Appl. No.: 10/982,613

(22) Filed: Nov. 3, 2004

(51) Int. Cl. G06F 9/46

(52) U.S. Cl. 718/100

(57) ABSTRACT

Systems and methods of managing processor threads provide for selecting a thread for execution by a processing architecture having a plurality of cores. A target core is selected from the plurality of cores based on a thread power value that corresponds to the thread. The thread is scheduled for execution by the target core.

### BACKGROUND

1. Technical Field

One or more embodiments of the present invention generally relate to thread management. More particularly, certain embodiments relate to thread scheduling based on thread power consumption data.

2. Discussion

As the trend toward advanced central processing units (CPUs) with more transistors and higher frequencies continues to grow, computer designers and manufacturers are often faced with corresponding increases in power consumption as well as denser concentrations of power. If power is too densely concentrated on a die, a “hot spot” can occur, making cooling more challenging and more expensive. As die sizes shrink, these difficulties increase in magnitude.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is a flowchart of an example of a method of managing threads according to one embodiment of the invention;

FIG. 2 is a flowchart of an example of a process of selecting a target core according to one embodiment of the invention;

FIG. 3 is a flowchart of an example of a process of identifying a thread power value according to one embodiment of the invention;

FIG. 4A is a flowchart of an example of a process of determining a plurality of thermal density indicators according to one embodiment of the invention;

FIG. 4B is a flowchart of an example of a process of determining a plurality of thermal density indicators according to an alternative embodiment of the invention;

FIG. 5 is a block diagram of an example of a processing architecture according to one embodiment of the invention;

FIG. 6 is a diagram of an example of a processor core according to one embodiment of the invention;

FIG. 7A is a diagram of an example of a processing system with a distributed workload according to one embodiment of the invention; and

FIG. 7B is a diagram of an example of a processing system with a distributed workload according to an alternative embodiment of the invention.

### DETAILED DESCRIPTION

In the following description, for purposes of explanation, numerous specific details are set forth in order to provide a thorough understanding of the embodiments of the present invention. It will be evident, however, to one skilled in the art that the embodiments of the present invention may be practiced without these specific details. In other instances, specific apparatus structures and methods have not been described so as not to obscure the embodiments of the present invention. The following description and drawings are illustrative of the embodiments of the invention and are not to be construed as limiting the embodiments of the invention.

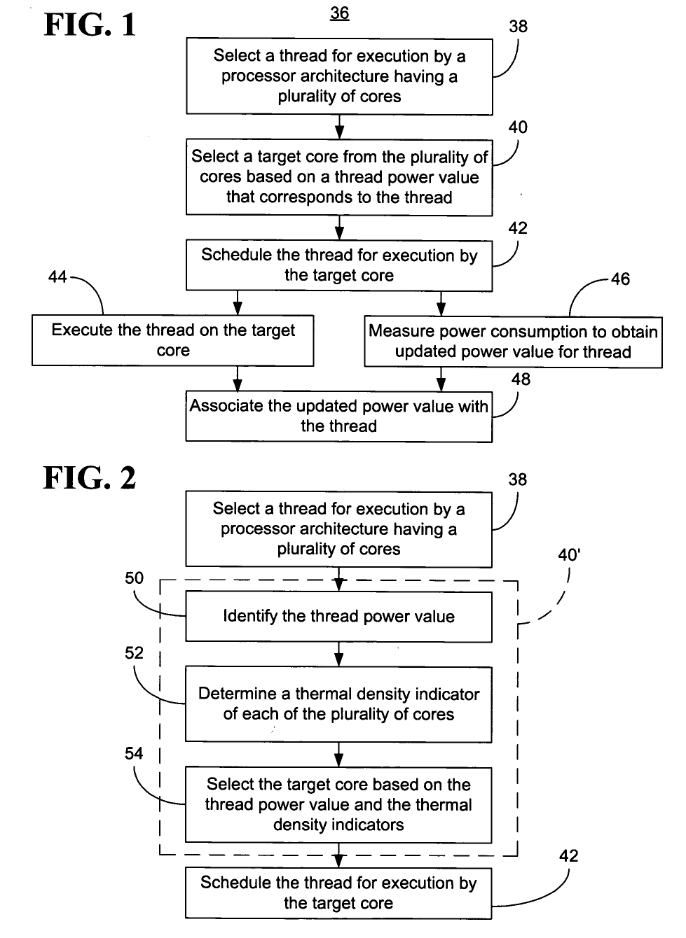

FIG. 1 shows a method 36 of managing threads that represents a substantial improvement over conventional approaches. The method 36 can be implemented in fixed functionality hardware such as complementary metal oxide semiconductor (CMOS) technology, microcode, software, or any combination thereof. In one embodiment, the method 36 is partially implemented as hardware in a processor core and partially as a set of instructions in an operating system (OS). For example, processing blocks 38, 40 and 42 may be implemented as a set of instructions stored in a machine readable medium, whereas processing blocks 44, 46 and 48 may be implemented as fixed functionality hardware. In the illustrated example, a thread is selected for execution at processing block 38, where the thread is to be executed by a processing architecture having a plurality of cores. Block 40 provides for selecting a target core from the plurality of cores based on a thread power value that corresponds to the selected thread. The thread power value, which can be either measured or estimated, may represent the power consumption associated with the thread in question. The thread is scheduled for execution by the target core at block 42.

It should be noted that traditional schedulers do not take power into consideration when selecting a target core. By selecting the target core based a thread power value, the illustrated method 36 enables the processing architecture to distinguish between threads that consume a relatively large amount of power and threads that do not. As result, more intelligent decisions can be made when scheduling threads. For example, the knowledge of thread power values can provide for the distribution of a workload across multiple cores in an effort to reduce thermal density.

Block 44 provides for executing the thread on the target core and block 46 provides for measuring the power consumption of the target core during the execution to obtain an updated power value for the thread. The measurement at block 46 need not be conducted each time a thread is run, although in systems having a great deal of leakage current variability due to environmental factors, for example, such an approach may be desirable. In addition, the measurement time period need not be the entire amount of time required to execute the thread, so long as the period is consistent from thread-to-thread. In fact, the time period can be fully configurable depending upon the circumstances. The updated power value is associated with the thread at block 48, where the associating can include storing the updated power value to a memory location, as described in greater detail below.

Turning now to FIG. 2, one approach to selecting the target core is shown in greater detail at block 40′. In particular the illustrated block 50 provides for identifying the thread power value and block 52 provides for determining a thermal density indicator of each of the plurality of cores. The thermal density indicators provide additional information about the status of the system. For example, the thermal density indicators could indicate that certain processor cores are contributing to the overall thermal density more so than others. The thread power value and the thermal density indicators can be used in block 54 to select the target core. Thus, if it is determined at block 54 that the selected thread is associated with a high power consumption, a core having a low thermal density indicator can be selected as the target core in order to reduce the thermal density of the overall processing architecture. The use of thread power values along with thermal density indicators can therefore lead to further power and/or thermal savings.

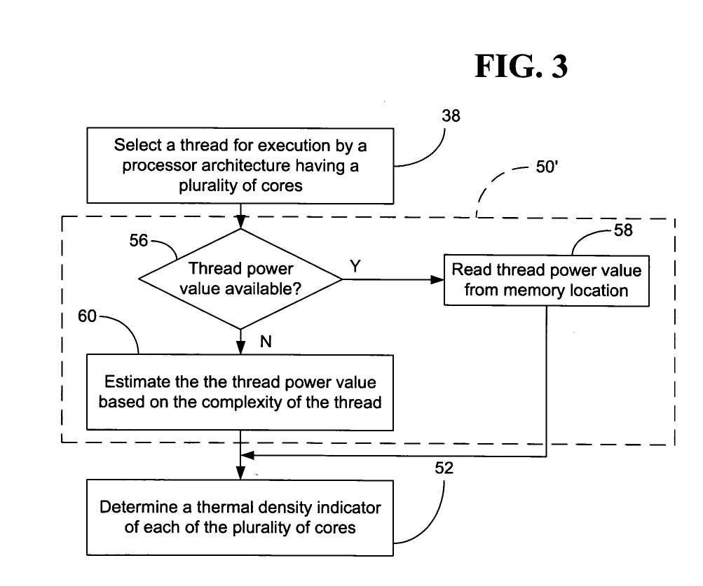

FIG. 3 shows one approach to identifying a thread power value in greater detail at block 50′. In particular, block 56 provides for determining whether the thread power value is available. If the thread power value is available, the thread power value is read from a memory location at block 58 in the illustrated example. Otherwise, block 60 provides for estimating the thread power value based on the complexity of the thread. The thread complexity could be provided by a software developer or compiler of the program with which the thread is associated. Thus, more complex code may translate into a higher thread power value and vice versa.

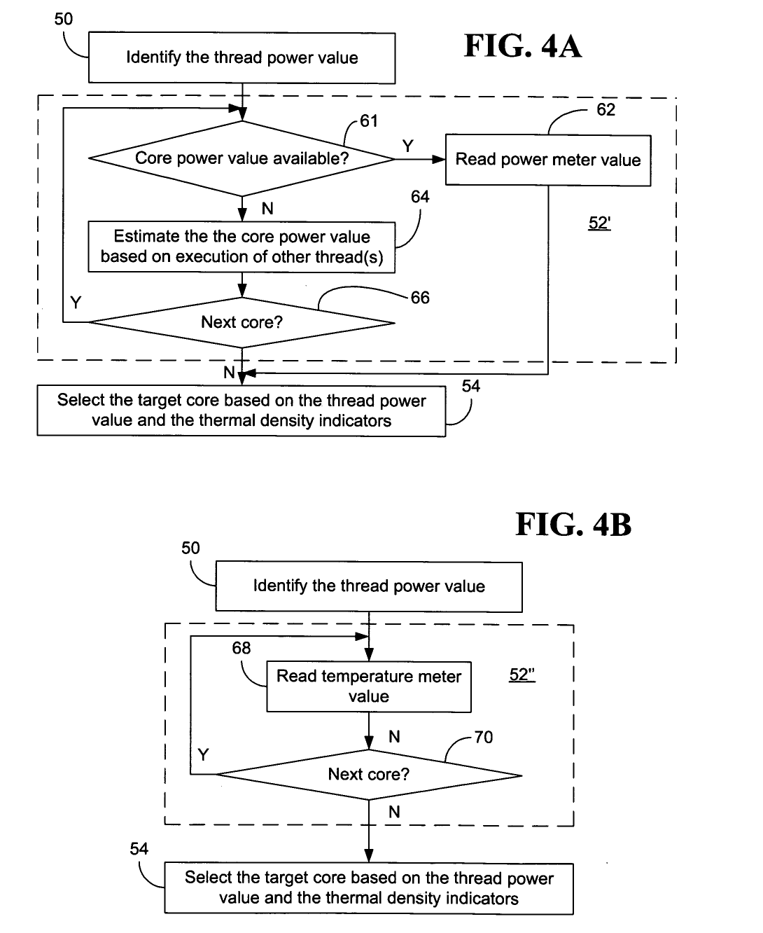

Turning now to FIG. 4A, one approach to determining a thermal density indicator for each of the plurality of cores is shown in greater detail at block 52′. In the illustrated example, it is determined whether a core power value is available from a power meter coupled to the core in question at block 61. If so, a power meter value is read at block 62. Otherwise, block 64 provides for estimating the core power value based on one or more threads previously executed on the core. One may estimate core power summing the thread power values for the threads run on the core in a given time quantum. Thus, if threads with high power values (or high complexity) were executed on the core, a high core power value may be estimated as a result of the summation. On the other hand, if threads with low power values (or low complexity) were executed on the core, a low core power value may be estimated as a result of the summation. Block 66 provides for selecting the next core in the plurality of cores.

FIG. 4B demonstrates an alternative approach to determining thermal density indicators at block 52″. In this example, core temperature is used as a thermal density indicator. Block 68 provides for reading a temperature meter value and block 70 provides for selecting the next core in the plurality of cores.

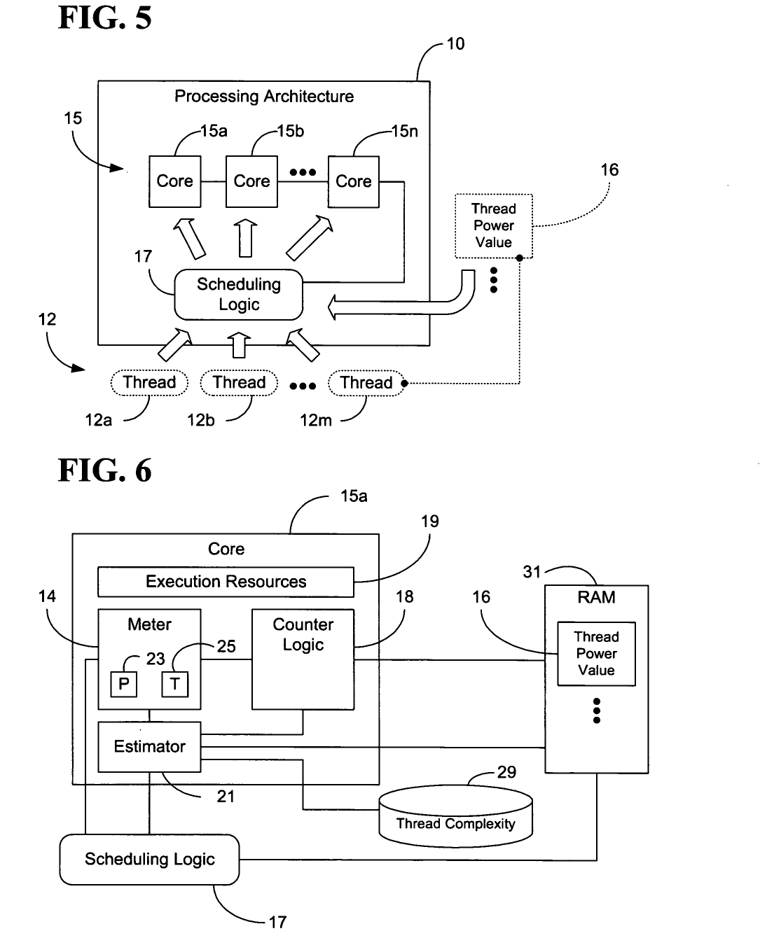

FIG. 5 shows a processing architecture 10 capable of executing one or more threads 12 (12a-12m), where the threads 12 represent a workload for the processing architecture 10. The illustrated architecture 10 includes a plurality of processor cores 15 (15a-15n), which can be similar to a Pentium® 4 processor core available from Intel® Corporation in Santa Clara, Calif. Each core 15 may therefore be fully functional with instruction fetch units, instruction decoders, level one (L1) cache, execution units, and so on (not shown). The processing architecture 10 could include a plurality of processor chips, where each chip includes a subset of the plurality of cores 15.

Each thread 12 may be any part of a program, process, instruction set or application that can be run independently of other aspects of the program, process, instruction set or application. The illustrated architecture 10 also includes scheduling logic 17 that is able to select a thread 12 for execution by the processing architecture 10. The scheduling logic 17 may be implemented in fixed functionality hardware, microcode, in software such as an operating system (OS), or any combination thereof. The selection of a thread 12 can be based on a wide variety of factors such as priority, dependency of one thread 12 over another, availability of resources, locality of instructions and data, etc.

The scheduling logic 17 is also able to select a target core from the plurality of cores 15 based on a thread power value that corresponds to the selected thread. In the illustrated example, the thread power value 16 corresponds to the thread 12m. The thread power value 16, which can be either measured or estimated, may represent the power consumption associated with the thread in question, namely, thread 12m. Once the target core is selected, the illustrated scheduling logic 17 schedules the selected thread for execution by the target core. By selecting the target core based on the thread power value 16, the illustrated processing architecture 10 is able to provide a number of advantages over conventional architectures. For example, scheduling decisions can be made based on the per-thread power consumption, which may lead to lower temperatures, simplified cooling schemes and/or greater power savings. In particular, it may be desirable to distribute the threads 12 across multiple cores in order to reduce the thermal density of the processing architecture 10.

Turning now to FIG. 6, one example of the use of thread power values and thermal density indicators is shown in greater detail. In particular, in the illustrated example, the processor core 15a includes execution resources 19 such as instruction fetch units, instruction decoders, L1 cache, execution units, etc., a meter 14, an estimator 21 and counter logic 18. The execution resources 19 can be used to run the scheduling logic 17 and execute threads, where the meter 14 is able to use a power component 23 to measure the power consumption of the core 15a and use a temperature component 25 to measure the temperature of the core 15a. The illustrated counter logic 18 can associate the thread power value 16 with the thread 12m (FIG. 1) by storing the thread power value 16 to a memory location such as a memory location in a random access memory (RAM) 31 or other memory structure. The thread power value 16 could be stored as part of other relevant thread information such as priority, dependency (e.g., parent and child thread identifiers), etc.

If the selected thread is new to the system, or otherwise does not have a thread power value associated with it, the illustrated estimator 21 may estimate the thread power value based on complexity data stored in a thread complexity database 29. The information in the thread complexity database 29 could be provided by a software developer or as part of a tool such as a compiler. The estimator 21 may also estimate core power values based on one or more threads that have previously been executed on the core 15a. For such an estimation, the estimator 21 might need access to the RAM 31. Thus, illustrated the scheduling logic 17 may identify the thread power value by either reading the thread power value from a memory location in the RAM 31 or retrieving an estimated thread power value from the estimator 21. The illustrated scheduling logic 17 can also determine a thermal density indicator of the core 15a by reading either a core power value or a core temperature value from the meter 14, or by retrieving an estimated core power value from the estimator 21. Once a thermal density indicator has been retrieved from each of the plurality of cores, the illustrated scheduling logic 17 can then select a target core based on the thread power value and the thermal density indicators.

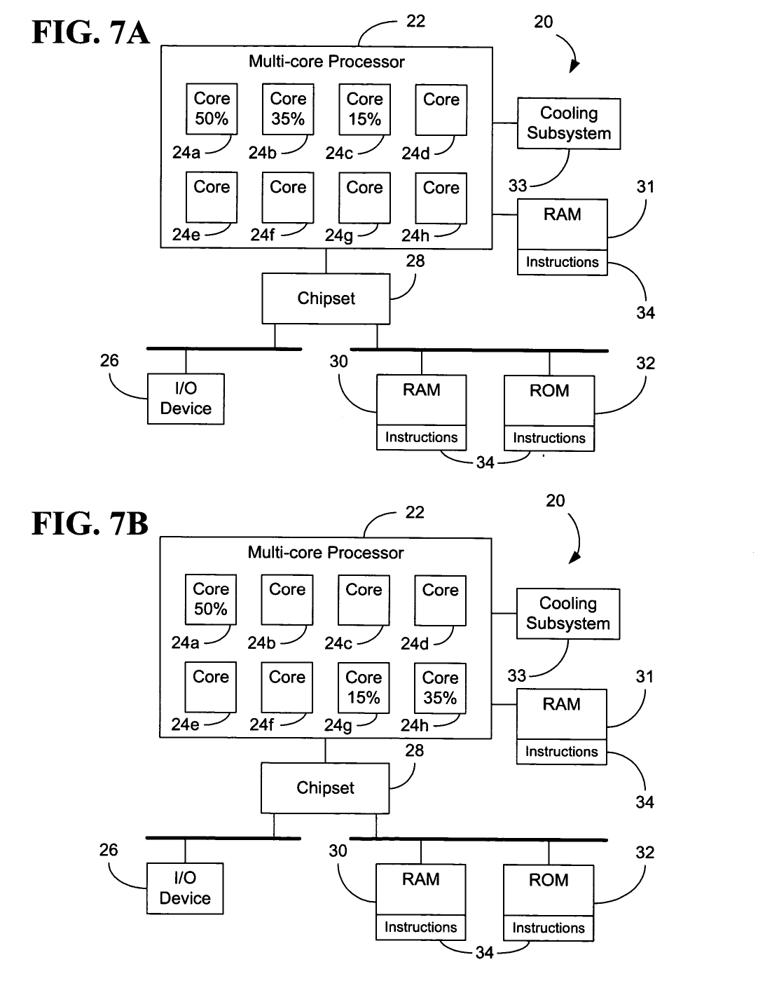

Turning now to FIG. 7A, a system 20 is shown in which a multi-core processor 22 has a plurality of cores 24 (24a-24h). Although the processor 22 is shown as having eight cores, the number of cores in the processor may be greater or fewer than the number shown. Furthermore, all of the cores need not be located on the same processor chip. Thus, the techniques described herein can be readily applied to single- or multi-socket computing systems that use multi-core processors, or multi-socket computing systems that use single core processors. In this regard, although some examples are described with regard to multi-core processors, the embodiments of the invention are not so limited. Indeed, any processing architecture in which power consumption is an issue of concern can benefit from the principles described herein. Notwithstanding, there are a number of aspects of multi-core processors for which the embodiments of the invention are well suited.

The system 20 may be part of a server, desktop personal computer (PC), notebook PC, handheld computing device, and so on. Each of the cores 24 may be similar to the cores 15 (FIGS. 5 & 6) discussed above, and may include a power meter and counter logic as already described. Alternatively, the power meter and control logic can be located elsewhere in the processor 22 and/or system 20. The processor 22 is coupled to one or more input/output (I/O) devices 26 and various memory subsystems either directly or by way of a chipset 28, where the thread power values (not shown) may be stored on any of the memory subsystems. In the illustrated example, the memory subsystems include a random access memory (RAM) 30 and 31 such as a fast page mode (FPM), error correcting code (ECC), extended data output (EDO) or synchronous dynamic RAM (SDRAM) type of memory, and may also be incorporated in to a single inline memory module (SIMM), dual inline memory module (DIMM), small outline DIMM (SODIMM), and so on. The memory subsystems may also include a read only memory (ROM) 32 such as a compact disk ROM (CD-ROM), magnetic disk, etc. The illustrated RAM 30, 31 and ROM 32 include instructions 34 that may be executed by the processor 22 as one or more threads.

In the illustrated example, a workload is distributed across three of the processor cores, namely, core 24a, core 24b and core 24c. As a result, processor 24a is 50% utilized, processor 24b is 35% utilized and processor 24c is 15% utilized. The workload distribution can be achieved by selectively allocating individual threads to the various processor cores. The decision to distribute the workload across the cores 24a-24c can be made based on the thread power value (e.g., power consumption) that is associated with each thread. A workload may therefore include one or more threads, where the threads may be assigned to one core or may distributed to multiple cores. For example, if a given thread is known to have a relatively high power consumption, it can be assigned to a core in such a fashion as to reduce the thermal density of the processor package. In this regard, it should be noted that conventional scheduling techniques do not take power consumption into consideration and would therefore most likely simply assign a given thread to either the core that last ran the thread or the first available core. The result could be a substantially greater risk of overheating and the need for more a costly cooling solution due to a greater power density.

For example, the system 20 could also include a cooling subsystem 33 that is coupled to the processor 22. The cooling subsystem 33 might include a forced airflow mechanism such as a fan that blows air over the processor 22 to reduce the temperature of the processor 22. In one embodiment, the cooling subsystem 33 can reduce airflow to the processor 22 by lowering the fan speed based on the reduced thermal density resulting from the techniques described herein. The reduced fan speed may lead to less power consumption, less noise and greater cost savings for the cooling subsystem 33.

FIG. 7B shows an alternative approach to distributing a thread in which the thermal density of the package is less than in the example given above. In particular, the workload is distributed so that processor 24h is 35% utilized, where core 24h is much farther away from core 24a than core 24b. In addition, core 24g is 15% utilized, where core 24g is also relatively far away from core 24a. By further decreasing the thermal density of the processor package, it is much easier to cool the processor 22. Simpler cooling techniques can lead to reduced cost, size and complexity of the overall system 20.

Thus, making use of power consumption data as described can enable better distribution of thermal loads and can lead to a significant reduction in junction temperature without compromising performance. Lowering the junction temperature can also lead to lower leakage power, which is paramount as processors continue to shrink. Lower temperatures can also provide for better reliability and lower acoustics due to more passive cooling techniques (e.g., slower fan speeds).

Those skilled in the art can appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. A method comprising:
selecting a thread for execution by a processing architecture having a plurality of cores;
selecting a target core from the plurality of cores based on a thread power value that corresponds to the thread; and
scheduling the thread for execution by the target core.

2. The method of claim 1, wherein selecting the target core includes:
identifying the thread power value;
determining a thermal density indicator of each of the plurality of cores; and
selecting the target core based on the thread power value and the thermal density indicator for each of the plurality of cores.

3. The method of claim 2, wherein the identifying includes reading the thread power value from a memory location.

4. The method of claim 2, wherein the identifying includes estimating the thread power value based on a complexity of the thread.

5. The method of claim 2, wherein the determining includes determining a core power value of each of the plurality of cores.

6. The method of claim 5, wherein determining each core power value includes reading a power meter value.

7. The method of claim 5, wherein determining each core power value includes estimating a core power value based on a power consumption of one or more threads that have previously been executed.

8. The method of claim 2, wherein the determining includes reading a temperature meter value of each of the plurality of cores.

9. The method of claim 1, further including:
executing the thread on the target core;
measuring a power consumption of the target core during the executing to obtain an updated power value for the thread; and
associating the updated power value with the thread.

10. The method of claim 9, wherein the associating includes storing the updated power value to a memory location.

11. A processing architecture comprising:
a plurality of cores; and
scheduling logic to select a thread for execution by the processing architecture, select a target core from the plurality of cores based on a thread power value that corresponds to the thread and schedule the thread for execution by the target core.

12. The architecture of claim 11, wherein the scheduling logic is to identify the thread power value, determine a thermal density indicator of each of the plurality of cores and select the target core based on the thread power value and the thermal density indicators.

13. The architecture of claim 12, wherein the scheduler is to read the thread power value from a memory location.

14. The architecture of claim 12, wherein the scheduler is to identify the thread power value by estimating the thread power value based on a complexity of the thread.

15. The architecture of claim 12, wherein the scheduler is to determine each thermal density indicator by determining a core power value of a corresponding core.

16. The architecture of claim 15, further including a power meter coupled to each of the plurality of cores, the scheduler to determine each core power value by reading a power meter value from the power meter.

17. The architecture of claim 15, further including an estimator to estimate each core power value based on a power consumption of one or more threads that have previously been executed.

18. The architecture of claim 12, further including a temperature meter coupled to each of the plurality of cores, the scheduler to determine each thermal density indicator by reading a temperature value from the temperature meter.

19. The architecture of claim 11, further including:
a power meter to measure a power consumption of the target core during execution of the thread to obtain an updated power value for the thread; and
counter logic to associate the updated power value with the thread.

20. The architecture of claim 19, wherein the counter logic is to store the updated power value to a memory location.

21. The architecture of claim 11, further including a plurality of processor chips, each processor chip including a subset of the plurality of cores.

22. A system comprising:
a processing architecture having a plurality of processor cores and scheduling logic to select a thread for execution by the processing architecture, select a target core from the plurality of cores based on a thread power value that corresponds to the thread and schedule the thread for execution by the target core; and
a cooling subsystem coupled to the processing architecture.

23. The system of claim 22, wherein the scheduling logic is to identify the thread power value, determine a thermal density indicator of each of the plurality of cores and select the target core based on the thread power value and the thermal density indicators.

24. The system of claim 22, wherein the processing architecture further includes:
a power meter to measure a power consumption of the target core during execution of the thread to obtain an updated power value for the thread; and
counter logic to associate the updated power value with the thread.

25. The system of claim 22, wherein the scheduler is to select a plurality of threads for execution by the processing architecture, select a target core for each of the plurality of threads based on a corresponding thread power value and schedule each of the plurality of threads for execution by a corresponding target core to reduce a thermal density of the processing architecture.

26. The system of claim 22, wherein the cooling subsystem is to reduce an airflow to the processing architecture based on the reduced thermal density.

27. A method comprising:
selecting a thread for execution by a processing architecture having a plurality of cores;
identifying a thread power value that corresponds to the thread by at least one of reading the thread power value from a memory location and estimating the thread power value based on a complexity of the thread;
determining a thermal density indicator of each of the plurality of cores by at least one of determining a core power value of each of the plurality of cores and reading a temperature meter value of each of the plurality of cores;
selecting a target core from the plurality of cores based on the thread power value and the thermal density indicator for each of the plurality of cores; and
scheduling the thread for execution by the target core.

28. The method of claim 27, wherein determining each core power value includes reading a power meter value.

29. The method of claim 27, wherein determining each core power value includes estimating a core power value based on a power consumption of one or more threads that have previously been executed.

30. The method of claim 27, further including:
executing the thread on the target core;
measuring a power consumption of the target core during the executing to obtain an updated power value for the thread; and
associating the updated power value with the thread.

31. A machine readable medium comprising a stored set of instructions which if executed are operable to:
select a thread for execution by a processing architecture having a plurality of cores;
select a target core from the plurality of cores based on a thread power value that corresponds to the thread; and
schedule the thread for execution by the target core.

32. The medium of claim 31, wherein the instructions are further operable to:
identify the thread power value;
determine a thermal density indicator of each of the plurality of cores; and
select the target core based on the thread power value and the thermal density indicator for each of the plurality of cores.

33. The medium of claim 32, wherein the instructions are further operable to read the thread power value from a memory location.

34. The medium of claim 32, wherein the instructions are further operable to estimate the thread power value based on a complexity of the thread.
